(19) United States
(12) Patent Application Publication
(10) Pub. No.: US 2022/0324693 A1
(43) Pub. Date: Oct. 13, 2022

(54) TAP AND CONTAINER OR BEER KEG HAVING A TAP

(71) Applicant: OAM GmbH, Wihelmsfeld (DE)

(72) Inventor: Timm Oberhofer, Wilhelmsfeld (DE)

(21) Appl. No.: 17/640,285

(22) PCT Filed: Aug. 6, 2020
(86) PCT No.: PCT/DE2020/200065

§ 371 Date: Mar. 3, 2022

(30) Foreign Application Priority Data
Sep. 4, 2019 (DE) 10 2019 213 421.1

(51) Int. Cl. B67D 3/04

(52) U.S. Cl. CPC B67D 3/047

(57) ABSTRACT

A tap for the removal of liquid from a container, such as a 5L party beer keg, comprises a sleeve, a piston which can be drawn at least partially out of the sleeve, an outlet head which adjoins the piston and can be pivoted, typically in relation to the longitudinal axis of the piston, and has an outlet, and an actuator which is generally assigned to the outlet or arranged downstream of the same. The actuator serves to draw the piston out of the sleeve and thereby activate the tap, and to pivot the outlet head and thereby open a flow path extending at least partially through the sleeve and the piston to the outlet for tapping purposes. The actuator comprises a handle for drawing the piston out of the sleeve (for activation) and an actuating lever which is connected to the handle for pivoting the outlet head (for tapping).

### BACKGROUND

### Technical Field

The disclosure relates to a tap for the removal of liquid from a container, in particular for the removal of beer from a beer keg. The beer keg is preferably a so-called 5L party beer keg.

Furthermore, the disclosure relates to a container, in particular a 5L party beer keg, which is equipped with a tap according to the disclosure.

### Description of the Related Art

As regards the generic prior art, both in relation to the tap and also in relation to the container or the beer keg, reference is made by way of example to PCT Publication No. WO 2018/234077 A1. A generic tap is known from this publication. A pivotable outlet head with an outlet and actuating means is already provided there, wherein the actuating means is a more or less flat handle. This handle serves both to draw out the piston into the working position and to pivot or tilt the outlet head for tapping.

In practice, the known actuating means is problematic since it combines several functions in itself, making operation more difficult for the inexperienced user. For the layman, it is not clear how the tap is brought into its working position nor how to tap. In addition, there is a risk that, at the same time as basic activation, tapping takes place unintentionally due to the outlet head pivoting. In addition, the outlet head can be rotated with the piston, possibly together with the sleeve, by excessive application of force, as a result of which leaks can arise. The handling of the known tap is therefore problematic and is far from the handling of a classic tap in the case of a large beer keg.

### BRIEF SUMMARY

It is therefore desired to develop a tap that can be moved easily into a working position in a manner that is easily recognizable from the outset. A subsequent operation, in particular tapping, should be possible without major explanations and unmistakably in function. In addition, in relation to the basic functionality, the tap should be similar to conventional taps in large beer kegs. Finally, the tap should differ in structure and in functionality from competing products, in particular according to PCT Publication No. WO 2010/069340 A1.

In various embodiments, the tap comprises a sleeve, a piston which can be drawn at least partially out of the sleeve, an outlet head, which adjoins the piston, that can be pivoted preferably in relation to the longitudinal axis of the piston and has an outlet, and an actuating means, which is preferably assigned to or arranged downstream of the outlet, wherein the actuating means serves to draw the piston out of the sleeve and thereby activate the tap and to pivot the outlet head and thereby open a flow path, extending at least partially through the sleeve and the piston, to the outlet for tapping purposes.

In various embodiments, the tap described herein is characterized in that the actuating means comprises an actuator having two functional units, namely a handle for drawing the piston out of the sleeve into the working position and an actuating lever, which is connected to the handle and intended for pivoting or tilting the outlet head forward or downward.

From the outset, a functional separation has been implemented here. For this purpose, the actuator has a handle by way of which the tap can be brought into its working position. Specifically, the handle is used for drawing the piston out of the sleeve until the working position of the piston is reached. An actuating lever is connected to the handle. This actuating lever serves for pivoting the outlet head as soon as it has been drawn completely out of the sleeve. Tapping takes place by pivoting or tilting the outlet head, as this in itself is known from WO 2010/069340 A1.

For the user, the functionality of the actuator is extremely simple, namely to the effect that the piston is drawn out of the sleeve into the working position of the tap by way of the handle and that tapping is effected with the actuating lever. The simplest construction results in operational simplicity.

Advantageously, the handle comprises a preferably ring-like or partially ring-like tab for bending out of the plane of the handle so that the actuator can be easily gripped for drawing out the piston. In this case, the tab can have fine webs in the sense of predetermined breaking points relative to the main body of the handle so that the webs are broken when the tab is bent out. In this way, a type of freshness seal is created, it being possible to see whether the tap or the piston thereof has already been operated or activated once.

As an alternative to the provision of the tab, the handle can preferably have shoulders projecting from the main body on both sides and having depressions serving for engagement behind the actuator. This creates a particularly stable design of the actuator or of the handle so that the piston can be easily drawn out of the sleeve into the working position by two fingers engaging behind the handle. For better positioning of the fingers, the shoulders can be equipped with depressions, as a result of which engagement behind the actuator is again favored.

The actuating lever, a further component of the actuator, advantageously has a very particular positioning or orientation, namely directed upward in a closed (zero) position. In other words, the actuating lever points upward in the rotational position of the outlet head that closes the flow path, i.e., in the closed position of the outlet head, whereby the aforementioned zero position is indicated. In a further advantageous manner, starting from its zero (closed) position, the actuating lever is pivotable forward or downward, namely for tapping. The tapping process can thus be carried out by pivoting the actuating lever, in a similar way to conventional taps. Tapping is ended again by bringing the actuating lever into the upward position.

The actuating lever can have an approximately round or flattened cross-section. With a flattened cross-section, the actuating lever can be easily manipulated with two fingers, in a similar way to a joystick.

With regard to manufacturing, it is advantageous if the outlet head is formed in one piece, preferably as a one-piece injection-molded part. It is also conceivable for individual parts of the outlet head to be latched into one another or with one another.

The outlet head is pivotably connected to the piston via an articulated joint, whereby the flow connection to the outlet is established by pivoting. The degree of pivoting can regulate the flow rate. The pivotability of the outlet head can be limited by lugs on the piston or side cheeks on the outlet head, which come to rest in both directions on the walls of the flow path in the outlet head, limiting the pivoting.

In a particularly advantageous manner, the piston is equipped with a marking which is just visible in the drawn-out working position of the piston relative to the free end of the sleeve, i.e., when the outlet head is drawn out, and in this case or thereby indicates the complete activation of the tap. The marking can be a groove or notch in the surface of the piston. The marking can also be colored. In any case, it is essential that the user recognizes a marking indicating the working position of the piston so that he does not attempt to draw the piston out further by exerting force and thereby draws the entire tap out of the container, for example, which does not seem impossible due to the favorable internal pressure in the container.

With regard to the maximum withdrawable working position of the piston in the sleeve, it is of further advantage if the piston latches in its working position, which the operator can feel when drawing it out. In addition to the simple latching, an inner stop can be provided in the sleeve, against which the piston comes to rest with a shoulder or the like at the moment of latching.

At its free end, the sleeve is advantageously equipped with a flange, a shoulder or the like, which serves as a stop during the sealing insertion of the sleeve through an opening formed in the container. During assembly, the sleeve is thus pushed or inserted through the opening completely into the container, for example into the party beer keg, until the flange comes to rest on the outer wall, preferably within a recessed insertion region. It is self-evident that sealing means act between the sleeve or the shoulder of the sleeve and the opening or wall of the container.

In a further advantageous manner, the sleeve or the flange of the sleeve is formed asymmetrically. Upon insertion into the opening of the container, the asymmetrical flange fits into a complementarily shaped receptacle of the insertion region of the container, providing an anti-rotation lock when the sleeve is inserted into the container. An undesired rotation of the sleeve, as a result of which leaks could possibly arise, is thereby effectively prevented.

Alternatively or additionally, a freshness seal can be assigned to the free end of the sleeve, preferably to the flange, which seal comprises a mechanical operative connection between the sleeve and the actuator in the inserted state. The operative connection is equipped with at least one predetermined breaking point so that when the piston is drawn out into its working position, the operative connection is visibly destroyed. Since this operative connection cannot be restored when the piston is pushed into the sleeve, an effective freshness seal is created here by simple means.

It should also be noted that along the flow path, different sealing means act between the sleeve and the piston and also between the piston and the outlet head. By providing the sealing means, it must be ensured that when the sleeve is installed and in any position of the piston, the tap is sealed to the outside, provided the actuator has not been actuated for tapping.

A container according to the disclosure, in particular a 5L party beer keg, is equipped with a tap of the type discussed above.

### BRIEF DESCRIPTION OF THE SEVERAL VIEWS OF THE DRAWINGS

There are various possibilities for designing and developing the teaching of the present disclosure in an advantageous manner. For this purpose, reference is made, on the one hand, to the claims and, on the other hand, to the explanation below of preferred exemplary embodiments of the disclosure on the basis of the drawings. In conjunction with the explanation of the preferred exemplary embodiments of the disclosure with reference to the drawings, generally preferred embodiments and developments of the teaching are also explained. Shown in the drawings are the following:

FIGS. 1a and 1b are schematic views of a 5L party beer keg with a recessed insertion region for a tap according to the present disclosure,

FIGS. 2a, 2b, and 2c are schematic views of the beer keg of FIGS. 1a and 1b, wherein the sleeve of the tap is inserted into the beer keg in the insertion region of the beer keg while forming an anti-rotation lock,

FIG. 3 is a schematic view of a 5L party beer keg with a completely inserted tap including a piston and actuator,

FIG. 4 is a schematic view of an exemplary embodiment of a tap according to the disclosure with a sleeve, piston, and outlet head,

FIGS. 5a, 5b, and 5c are different schematic views of the pivotable outlet head including an actuator and outlet according to the exemplary embodiment of FIG. 4,

FIG. 6 is a schematic view of a further exemplary embodiment of a tap according to the disclosure with a sleeve, piston, and outlet head,

FIGS. 7a, 7b, and 7c are different schematic views of the pivotable outlet head including an actuator and outlet according to the exemplary embodiment of FIG. 6,

FIGS. 8a to 8c are different schematic views of an exemplary embodiment of a sleeve of the tap according to the disclosure with a freshness seal, which can be mechanically connected to the actuator, and

FIGS. 9a and 9b are schematic views of an exemplary embodiment of a piston with a groove-like marking for identifying the working position of the piston relative to the sleeve.

### DETAILED DESCRIPTION

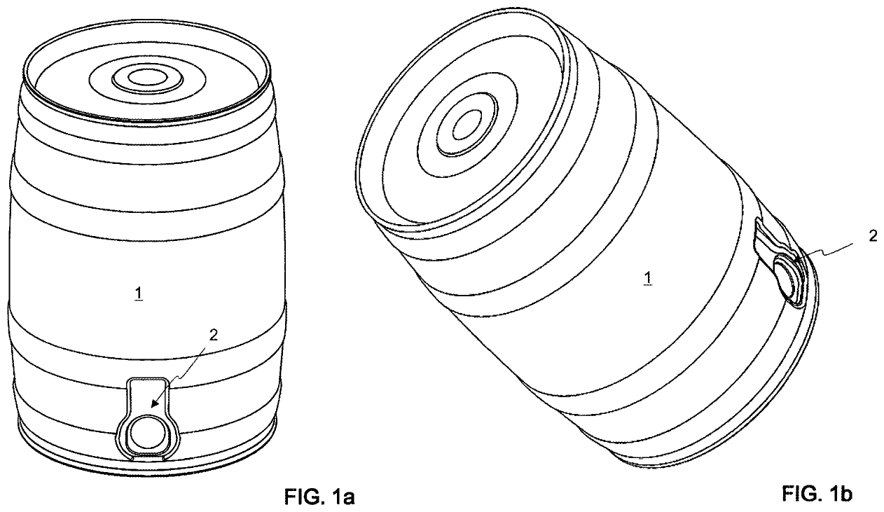

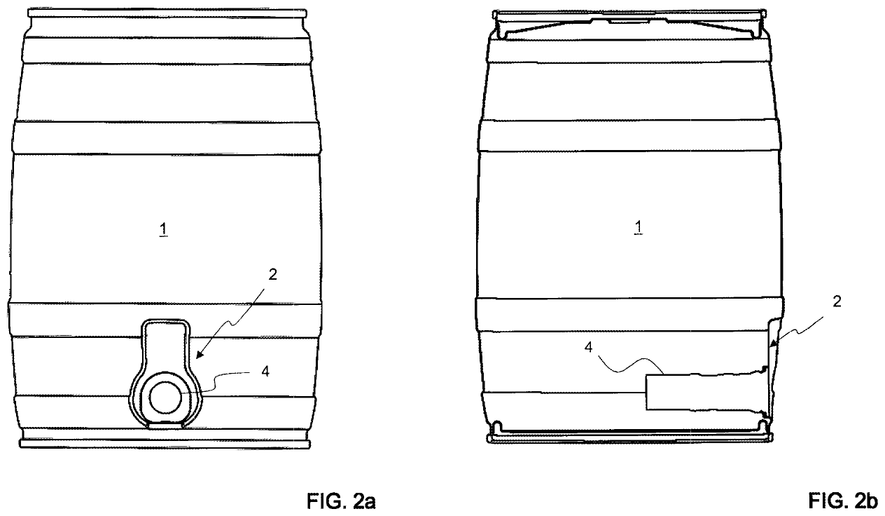

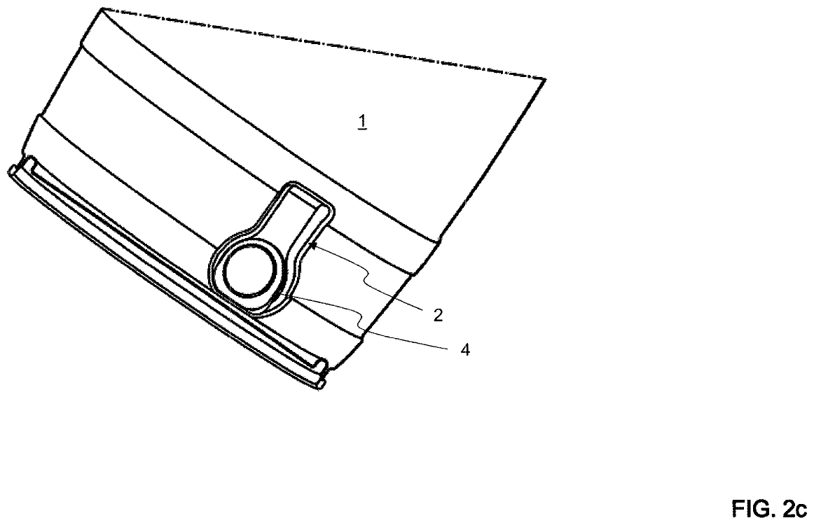

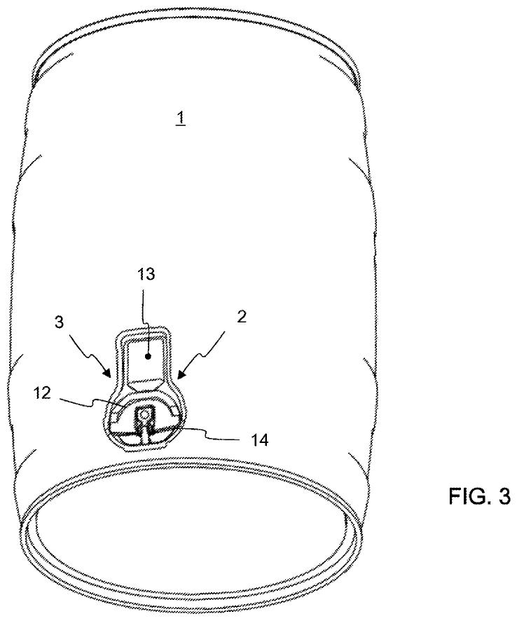

FIGS. 1 and 2 show a container 1, namely a 5L party beer keg. The beer keg 1 is equipped with a special receiving or insertion region 2 for inserting and fastening a tap 3. Due to the asymmetrical design of the receiving region 2, the receiving region 2 and a correspondingly equipped flange of the tap 3 act in the sense of an anti-rotation lock.

FIGS. 2a, 2b, and 2c show the beer keg 1 with the receiving region 2, wherein a sleeve 4 of the tap 3 is inserted.

FIG. 3 shows the beer keg 1 with an overall inserted tap 3, whose components are shown in the following figures and are discussed in the corresponding figure description.

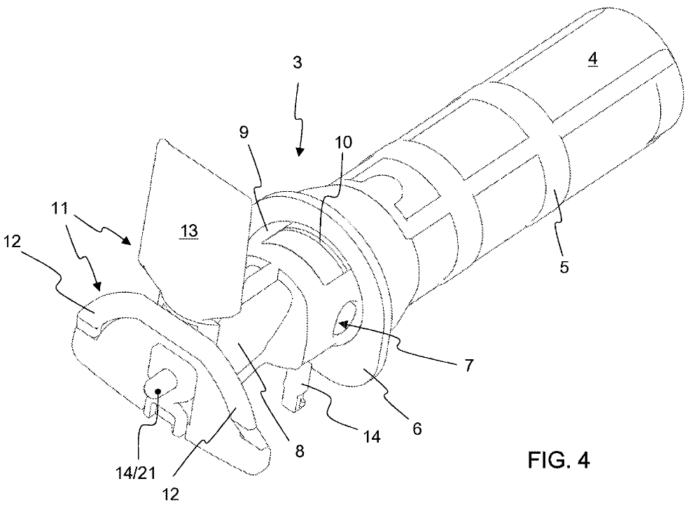

FIG. 4 shows an exemplary embodiment of a tap 3 with its components. This includes the sleeve 4, which is equipped with stabilizing structures 5. At its free end, the sleeve 4 has a flange 6, with which it comes to rest at the outer side of the beer keg 1 in the receiving region 2 thereof. Due to the asymmetrical design of both the flange 6 and the receiving region 2, an anti-rotation lock is created when the sleeve 4 is in the inserted state.

FIG. 4 also shows a joint 7, via which an outlet head 8 is pivotably articulated on the piston 9.

The piston 9 is provided with a marking 10 which indicates to the user that or whether the piston 9, and especially the outlet head 8, has been properly drawn out of the sleeve 4 so that the tap 3 is ready for operation.

The outlet head 8 is equipped with an actuator 11 which comprises a handle 12 for drawing the piston 9 together with the outlet head 8 out of the sleeve 4. The actuator 11 furthermore comprises an actuating lever 13, which serves to pivot the outlet head 8 forward or downward.

FIG. 4 also shows the components of the freshness seal 14, wherein the mechanical elements thereof are disengaged by breaking after the piston 9 has been drawn out. The connection of the mechanical elements 14 of the freshness seal is destroyed via a predetermined breaking point and can in this respect be seen by the user.

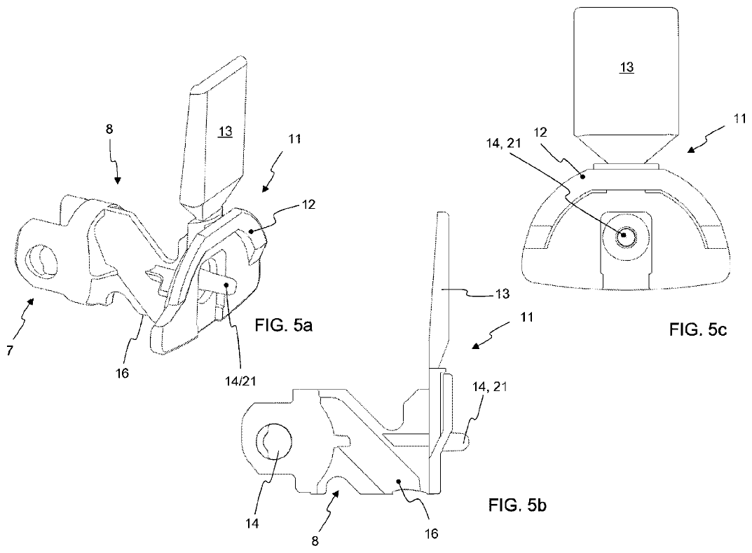

FIGS. 5a to 5c show, seen individually and enlarged, the outlet head 8 with the actuator 11, which comprises the forward bendable handle 12 and the actuating lever 13. In addition, it can be seen in FIGS. 5a to 5c that the outlet head 8 has a joint 15 with which the outlet head 8 is mechanically and also fluidically connected to the piston (not shown in FIGS. 5a to 5c).

FIGS. 5a to 5c also show the outlet 16, which can be pivoted relative to the longitudinal axis of the piston (not shown) by means of the actuating lever 13, whereby tapping is initiated, depending on the degree of pivoting.

Furthermore, the mechanical element 14 of the freshness seal assigned to the outlet head 8 can be seen in FIGS. 5a to 5c.

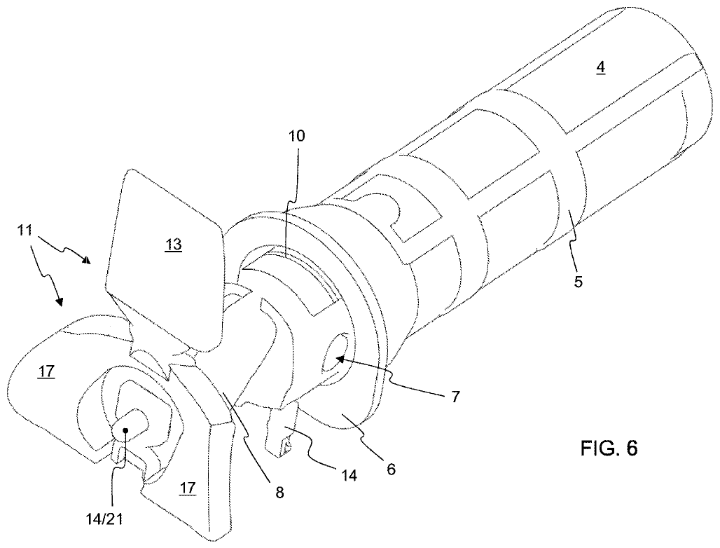

FIG. 6 shows a further exemplary embodiment of a tap 3 according to the disclosure, in which the actuator 11 has a special handle 12, namely in the form of shoulders 17 formed on both sides of the main body of the actuator 11, which shoulders can be engaged behind by two fingers in order to draw out the piston 9. An actuating lever 13 is arranged above the shoulders 17, in a similar way to the exemplary embodiment of FIGS. 4 and 5.

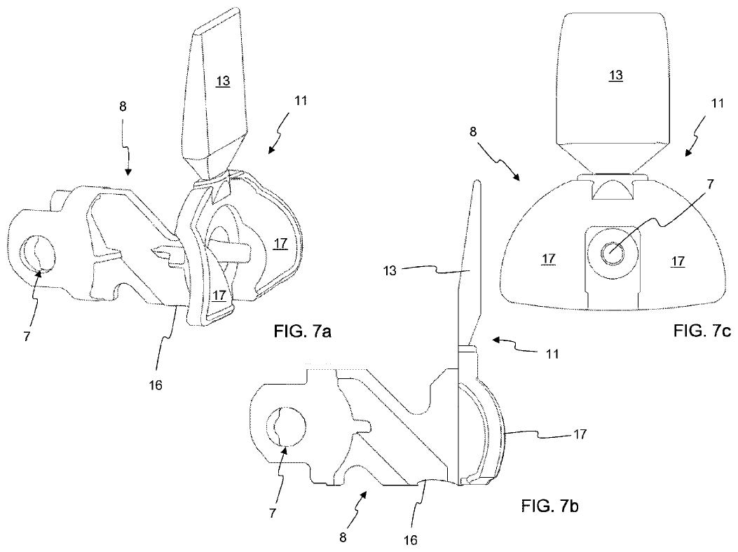

FIGS. 7a to 7c show the outlet head 8 together with the actuator 11, corresponding to the design of the tap 3 of FIG. 6. Special explanations are superfluous with reference made to the exemplary embodiment of FIGS. 4 and 5.

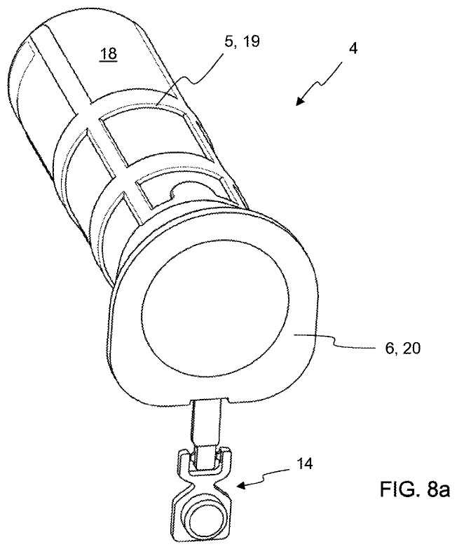

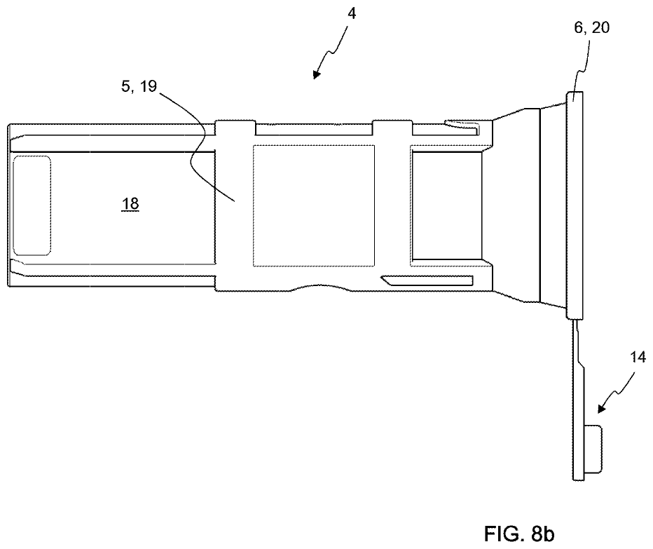

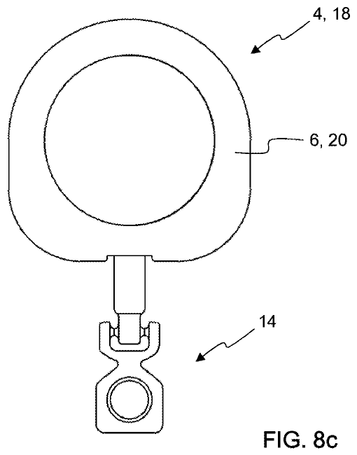

FIGS. 8a to 8c show an exemplary embodiment of a sleeve 4, as is used in the exemplary embodiments of the taps of FIGS. 4 and 5 and also 6 and 7.

The sleeve 4 has a sleeve body 18, which has reinforcing structures 19. These structures are formed on the surface of the sleeve body 18.

At the free end, the sleeve body 18 is provided with a flange 20, which is designed as an asymmetrical circular ring. It comes into contact with the outer surface of the beer keg 1 in the likewise asymmetrically formed receiving region 2 thereof and acts together with the receiving region 2 as an anti-rotation lock.

In the lower region of the flange 20, mechanical elements 14 formed as part of a freshness seal are provided and interact with a corresponding receptacle 21 in the outlet head 8. When the piston 9 together with the outlet head 8 is drawn out into the working position, the mechanical elements 14, 21 are recognizably separated from one another so that the user sees that the freshness seal created by the mechanical elements 14, 21 has been broken open. This is irreversible, which speaks for the quality of the freshness seal.

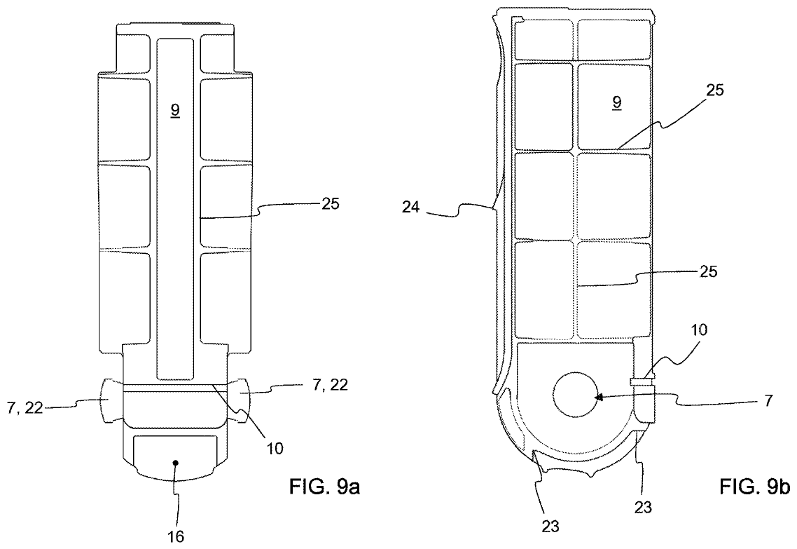

FIGS. 9a and 9b show pivot axes 22 formed at the head-side end of the piston 9 in the sense of pivoting bodies which are used for receiving or attaching corresponding recesses or passages in the outlet head 8. As a result, a pivotable mechanical and fluidic connection between the piston 9 and the outlet head 8 can be created.

In addition, the piston 9 is equipped with mechanical pivot limits 23 which effectively limit the pivoting movement of the outlet head 8.

Furthermore, the piston 9 has a latching feature which interacts with complementary elements on the inside of the sleeve 4 and limits the draw-out movement of the piston 9 relative to the sleeve 4. An internal anti-rotation lock prevents rotation of the piston 9 within the sleeve 4. A sealing surface of the piston 9 is indicated by reference sign 24 and seals the piston 9 against the sleeve 4. FIG. 9a furthermore shows a longitudinal groove at reference sign 9. In the assembled state, a stud which is formed on the sleeve 4 projects into this groove. When the piston 9 is drawn, it moves along the stud. If attempts were made to rotate the piston 9, the stud would block the rotation of the piston 9 within the sleeve 4.

On the surface, the piston 9 is also equipped with reinforcing structures 25.

It should be noted at this point that, according to various embodiments, all elements of the tap are preferably made of plastic and are preferably produced by injection molding.

With regard to further advantageous embodiments of the device according to the disclosure, reference is made to the general part of the description and to the appended claims in order to avoid repetitions.

Finally, it should be expressly pointed out that the exemplary embodiments of the tap according to the disclosure described above serve only to explain the claimed teaching but do not limit the teaching to the exemplary embodiments.

### LIST OF REFERENCE SIGNS

1 Container, beer keg

2 Receiving region (on the container)

3 Tap

4 Sleeve of the tap

5 Stabilizing structures on the outer surface of the sleeve

6 Flange of the sleeve

7 Joint (between piston and outlet head)

8 Outlet head

9 Piston

10 Marking in the outer surface of the piston

11 Actuator (at the outlet head)

12 Handle (of the actuating means)

13 Actuating lever (of the actuating means)

14 Freshness seal, mechanical element

15 Joint

16 Outlet of the outlet head

17 Shoulders of the actuator

18 Sleeve body

19 Reinforcing structures on the sleeve body

20 Flange

21 Receptacle

22 Pivot axis

23 Pivot limit

24 Sealing surface

25 Reinforcing structures in the surface of the piston

The various embodiments described above can be combined to provide further embodiments. All publications referred to in this specification and/or listed in the Application Data Sheet are incorporated herein by reference, in their entirety. Aspects of the embodiments can be modified, if necessary to employ concepts of the various publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A tap for removal of liquid from a container, comprising:
a sleeve,
a piston which can be drawn at least partially out of the sleeve,
an outlet head which adjoins the piston and can be pivoted and has an outlet, and
an actuator, wherein the actuator serves to draw the piston together with the outlet head out of the sleeve and thereby activate the tap, and to pivot the outlet head and thereby open a flow path extending at least partially through the sleeve and the piston to the outlet for tapping purposes,
wherein the actuator comprises:
a handle for drawing the piston out of the sleeve, and
an actuating lever for pivoting the outlet head.

2. The tap according to claim 1, wherein the handle comprises a tab for bending out of a plane of the handle and for engagement of the actuator.

3. The tap according to claim 1, wherein the handle comprises shoulders for engagement behind the actuator.

4. The tap according to any one of claim 1, wherein the actuating lever points upward in a rotational position of the outlet head closing the flow path and thus in a closed position of the outlet head.

5. The tap according to claim 4, wherein, starting from the closed position, the actuating lever is pivotable for tapping.

6. The tap according to claim 5, wherein the actuating lever for tapping is pivotable forward or downward such that the outlet of the outlet head is directed downward.

7. The tap according to claim 1, wherein the actuating lever has an approximately round or flattened cross-section.

8. The tap according to claim 1, wherein the outlet head is made in one piece.

9. The tap according to claim 1, wherein the outlet head is pivotably connected to the piston via an articulated joint.

10. The tap according to claim 1, wherein the piston has a marking which is just visible in a drawn-out working position of the piston relative to a free end of the sleeve, thereby indicating activation of the tap.

11. The tap according to claim 10, wherein the marking is a groove or notch in a surface of the piston.

12. The tap according to claim 1, wherein the piston in a maximum withdrawable working position latches in the sleeve.

13. The tap according to claim 1, wherein the piston is a rotationally fixed within the sleeve.

14. The tap according to claim 1, wherein, at a free end of the sleeve, the sleeve has a flange or shoulder which serves as a stop during a sealing insertion into an opening in the container.

15. The tap according to claim 14, wherein the sleeve is formed asymmetrically and fits into a complementarily shaped receptacle of the container, creating an anti-rotation lock when the sleeve is inserted into the container.

16. The tap according to claim 1, wherein a freshness seal is assigned to a free end of the sleeve and comprises a mechanical operative connection between the sleeve and the outlet element in an inserted state of the piston, said connection being visibly destroyed by drawing out the piston into a working position.

17. The tap according to claim 1, further comprising sealing means that act along the flow path between the sleeve and the piston and also between the piston and the outlet head.

18. A container with a tap according to claim 1.

19. The tap according to claim 1, wherein the outlet head can be pivoted in relation to a longitudinal axis of the piston.

20. The tap according to claim 1, wherein the actuator is assigned to or arranged downstream of the outlet, or the actuating lever is connected to the handle.
